(19) United States
(12) Patent Application Publication
(10) Pub. No.: US 2005/0186057 A1
(43) Pub. Date: Aug. 25, 2005

(54) Vehicle sideloading elevator platform

(75) Inventor: Darel J. Reicks, New Hampton, IA (US)

Correspondence Address: THOMAS E. HILL;EMRICH & DITHMAR, LLC, 125 SOUTH WACKER DRIVE, SUITE 2080, CHICAGO, IL, 60606-4401, US

(73) Assignee: L&R Manufacturing, L.L.C.

(21) Appl. No.: 10/782,578

(22) Filed: Feb. 19, 2004

(51) Int. Cl. B60P 1/00

(52) U.S. Cl. 414/556

(57) ABSTRACT

A sideloading elevator mounted to a bed of a trailer body is movable between a non-use, retracted configuration, wherein the elevator is stowed beneath the trailer in an upraised position, and an extended use configuration, wherein the elevator is movable between an elevated position laterally adjacent the trailer and a lowered position on the ground. A carriage attached to a lower portion of the trailer's bed is movable by a first hydraulic cylinder between retracted and extended positions. A support platform connected to the transport mechanism by pivoting linkage is movable by a second hydraulic cylinder between the elevated and lowered positions. Chains attached to the trailer body and to the support platform maintain the elevator in the upraised, retracted configuration for trailer transport. The pivoting linkage includes four parallel, angled links each having first and second opposed ends respectively connected in a pivoting manner to the carriage and platform.

### FIELD OF THE INVENTION

This invention relates generally to loading and unloading of commercial vehicles such as trucks and trailers, and is particularly directed to a sideloading elevator attached to a trailer and movable between a retracted, nonuse position for vehicle transport and an extended use position, wherein a support platform of the elevator is movable between an upraised position adjacent an access opening in a lateral wall of the vehicle and a lowered position adjacent the ground or floor.

### BACKGROUND OF THE INVENTION

Commercial vehicles such as trucks and tractor trailers are typically loaded or unloaded at a dock which is located generally at the same height as the floor, or bed, of the truck/trailer. The truck/trailer typically backs up to the loading/unloading dock, a temporary ramp is placed between the truck/trailer and the dock, and goods are easily loaded onto or offloaded from the truck/trailer by hand such as with hand trucks, by a powered vehicle such as a forklift, or by a conveyor.

Some vehicles are provided with self-contained elevators which are useful in loading/offloading cargo when a dock facility is not available. This type of elevator, which is integral with the truck/trailer, generally includes a horizontal, flat platform which can be raised to the truck/trailer bed and lowered to the ground or floor. The platform is movably attached to the truck/trailer by a power driven mechanism which is capable of lifting heavy loads. The elevator's platform is sometimes movable between the horizontal orientation for receiving and supporting goods and a generally vertical orientation where the platform also serves to at least partially close the cargo opening of the truck/trailer. With the platform disposed in a generally vertical orientation over the cargo opening, the vehicle is configured for transport. In some cases, the platform is stowed beneath the vehicle body when not in use to facilitate vehicle transport.

In these types of vehicles, it is frequently desirable to also include a cargo opening in a lateral wall of the vehicle body to accommodate a wider range of cargo handling installations. In some cases, a vehicle incorporating a side cargo opening is also provided with an integral elevator arrangement to facilitate loading and unloading goods. This type of installation is somewhat impractical in most trucks because of the presence of various components disposed beneath the truck bed such as the truck's driveshaft, frame and rear suspension. However, this is generally not a problem in tractor-trailers which are much simpler in construction and have fewer components than the aft, lower portion of a cargo truck. Thus, the use of cargo elevator arrangements integrally mounted to a lower, outer portion of the trailer bed is common in these types of vehicles. However, clearance requirements beneath the tractor-trailer as well as the hostile environment encountered beneath the tractor-trailer, particularly in the case of long-haul, over-the-road tractor-trailers, places severe demands on the structure and operation of the elevator platform. For example, rocks and other debris are frequently thrust up from the roadway into contact with the tractor-trailer's undercarriage. In addition, roadway corrosives such as salt and acids place severe demands on the operation of any non-enclosed structure located beneath the tractor-trailer's bed. Finally, any elevator arrangement when in the nonuse, retracted configuration must be provided with sufficient clearance to avoid impact with hazzards on the road as well as those encountered in cargo loading/offloading depots.

The present invention addresses the aforementioned configuration and operating requirements of an elevator platform mounted adjacent a side cargo door of a tractor-trailer by providing an easily operated, highly reliable installation using a reduced number of parts and requiring a reduced operating and storage space.

### OBJECTS AND SUMMARY OF THE INVENTION

Accordingly, it is an object of the present invention to facilitate the loading and unloading of a commercial vehicle such as a tractor-trailer via a side opening in the vehicle.

It is another object of the present invention to provide a sideloading elevator platform for a vehicle movable between an upraised position adjacent the vehicle's bed and a lowered position adjacent the ground or floor for loading goods on or offloading goods from the vehicle.

Yet another object of the present invention is to provide a loading/unloading platform mechanism for a vehicle movable between a use and nonuse, stowed position located beneath the vehicle's bed and a use, extended position located adjacent a side opening in the vehicle.

A still further object of the present invention is to provide an elevator platform adapted for positioning between a first use position adjacent a side access door in a vehicle for loading/unloading of the vehicle and a second stowed position closely disposed beneath the vehicle for transport wherein the elevator platform is securely maintained in the stowed position by chains attached to the vehicle.

The vehicle sideloading elevator platform of the present invention incorporates a folding platform connected by pivoting linkage to a transport mechanism disposed on the lower surface of the tractor-trailer's bed. A first hydraulic cylinder moves the transport mechanism between a stowed, nonuse position and an extended, use position. When in the stowed position, the elevator platform is folded and is disposed adjacent the transport mechanism, with both the transport mechanism and folded elevator platform in closely spaced relation to the tractor-trailer's bed. With the transport mechanism in the use position, a second hydraulic cylinder allows the elevator platform to be moved between an elevated position adjacent the tractor-trailer's side cargo door and a lowered position on or adjacent to the ground or a floor. The elevator platform is securely maintained in the retracted, stowed position by means of chains which suspend the elevator platform from the tractor-trailer's bed.

More specifically, the inventive sideloading elevator is intended for use with a cargo trailer having plural sidewalls and a bottom bed, wherein one of the sidewalls has an access opening for loading cargo on or off-loading cargo from the trailer, with the sideloading elevator comprising: a transport mechanism moveably attached to a lower portion of the trailer's bed; a first hydraulic cylinder attached to a lower portion of the trailer's bed and coupled to the transport mechanism for moving the transport mechanism between a retracted position and an extended position wherein the transport mechanism is located adjacent the access opening; first and second pairs of angled arms each having respective first and second opposed ends, wherein the first ends of the angled arms are pivotally coupled to the transport mechanism; a platform adapted to receive and support cargo, wherein the platform is pivotally coupled to a second end of each of the angled arms; and a second hydraulic cylinder coupled to an intermediate portion of each of the angled arms for moving the platform between a folded configuration when the transport mechanism is in the retracted position for transport of the trailer and an unfolded configuration when the transport mechanism is in the extended position for using the platform to receive and support cargo, wherein the platform is raised and lowered by the second hydraulic cylinder when the transport mechanism is in the extended position.

### BRIEF DESCRIPTION OF THE DRAWINGS

The appended claims set forth those novel features which characterize the invention. However, the invention itself, as well as further objects and advantages thereof, will best be understood by reference to the following detailed description of a preferred embodiment taken in conjunction with the accompanying drawings, where like reference characters identify like elements throughout the various figures, in which:

FIG. 1 is a perspective view illustrating a vehicle sideloading elevator platform of the present invention in the lowered, extended configuration;

FIG. 2 is a perspective view of the inventive vehicle sideloading elevator platform in the fully upraised, extended configuration;

FIG. 3 is a perspective view of the inventive vehicle sideloading elevator platform in the nonuse, stowed configuration;

FIG. 4 is a lateral elevation view of the inventive vehicle sideloading elevator platform in the extended, upraised configuration, with the elevator platform folded;

FIG. 5 is a lateral elevation view of the inventive vehicle sideloading elevator platform shown in the partially upraised, extended configuration;

FIG. 6 is a lateral elevation view of the inventive vehicle sideloading elevator platform shown in the retracted, stowed configuration;

FIG. 7 is a lateral elevation view of the inventive vehicle sideloading elevator platform shown in the use, fully upraised configuration, with the elevator platform fully extended;

FIG. 8 is a lateral elevation view of the inventive vehicle sideloading elevator platform shown in the use, partially upraised configuration, with the elevator platform fully extended;

FIG. 9 is a lateral elevation view of the inventive vehicle sideloading elevator platform shown in the use, lowered configuration, with the elevator platform fully extended;

FIG. 10 is an end-on view of the inventive vehicle sideloading elevator platform shown in the use, partially upraised configuration;

FIG. 11 is an end-on view of the inventive vehicle sideloading elevator platform shown in the use, lowered configuration; and

FIG. 12 is a top view shown partially in phantom of the inventive vehicle sideloading elevator platform.

### DETAILED DESCRIPTION OF THE PREFERRED EMBODIMENTS

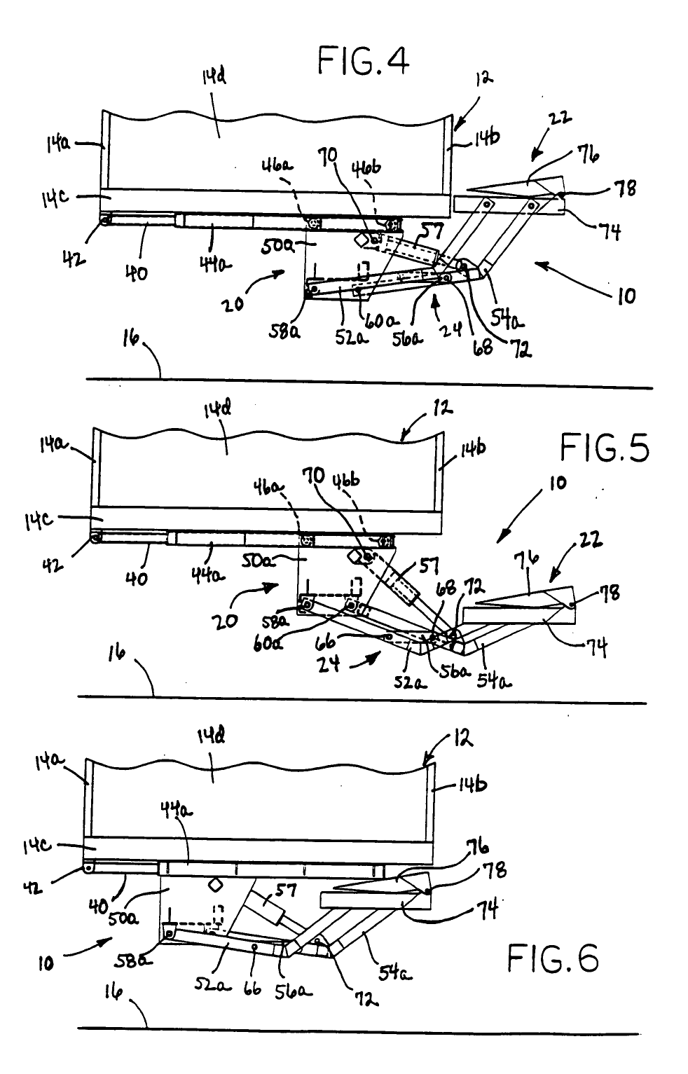

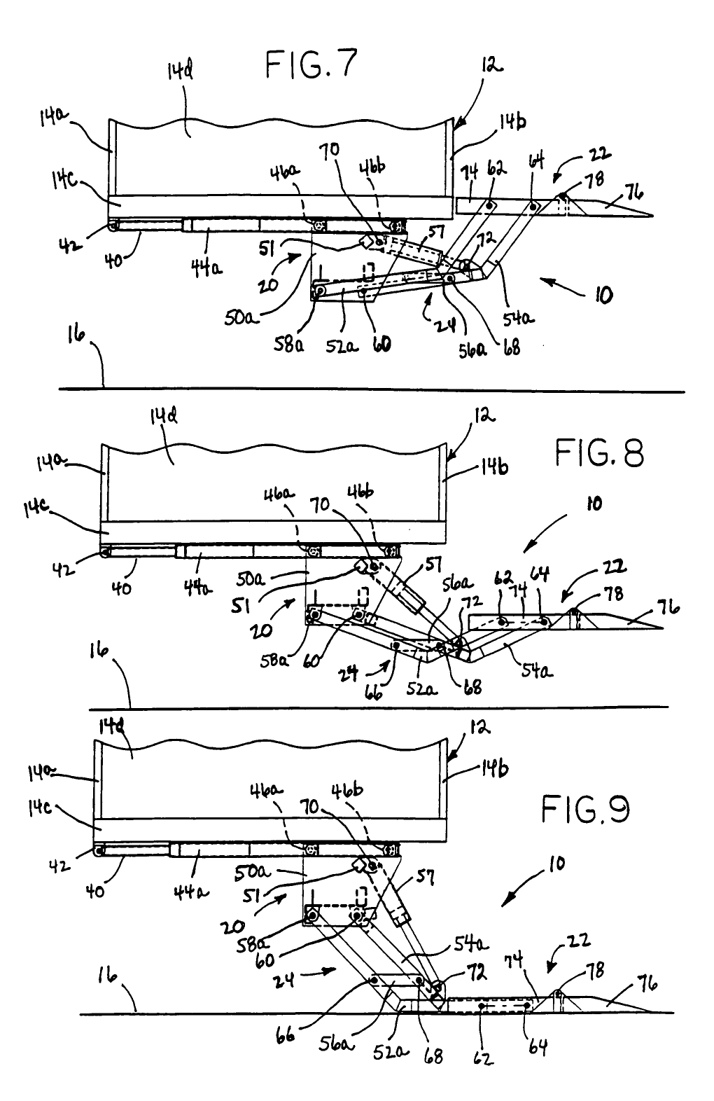

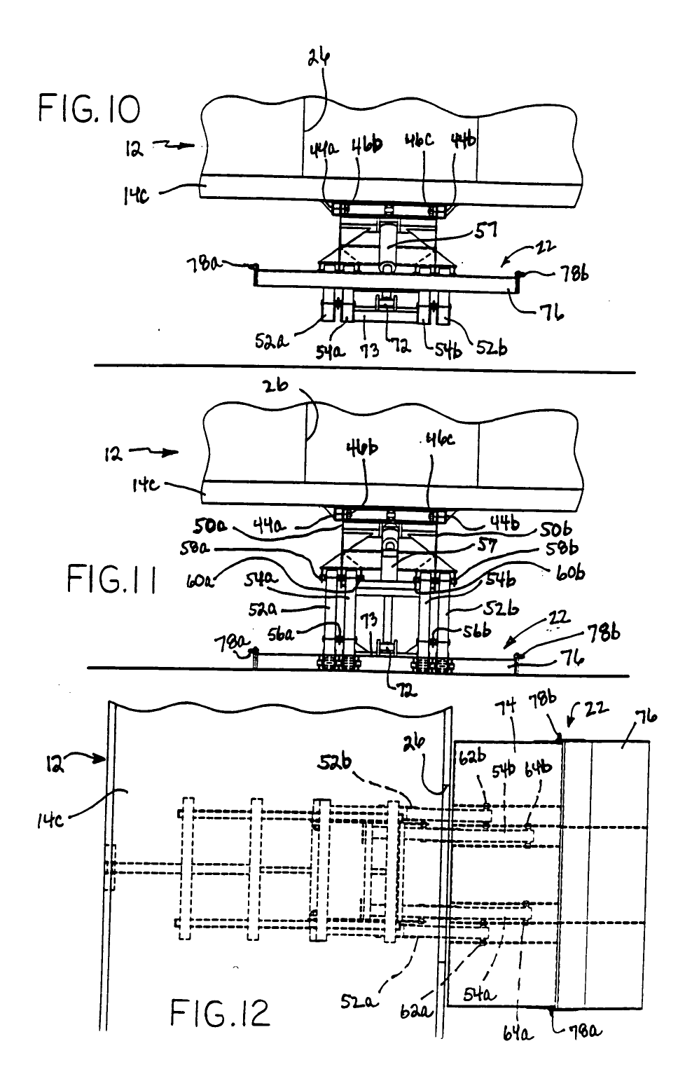

Referring to FIGS. 1, 2 and 3, there are perspective views of a vehicle sideloading elevator platform 10 in accordance with the present invention in the extended, fully lowered configuration; the extended, fully upraised configuration; and the folded, or stowed, configuration, respectively. FIGS. 4, 5 and 6 are rear lateral views of a vehicle sideloading elevator platform 10 in accordance with the present invention illustrating the platform in the extended, fully upraised configuration; the extended, partially raised configuration; and the folded, or stowed, configuration, respectively. FIGS. 7, 8 and 9 are rear lateral views of the inventive elevator platform 10 respectively shown in the extended, fully elevated configuration; the extended, partially elevated configuration; and the extended, fully lowered configuration. FIGS. 10 and 11 are end-on views of the inventive elevator platform 10 shown respectively in the extended, partially elevated configuration and the extended, fully lowered configuration. FIG. 12 is a top plan view shown partially in phantom of the elevator platform 10 of the present invention. The configuration and operation of the inventive elevator platform 10 will now be described in the following paragraphs with respect to the various aforementioned figures.

The vehicle sideloading elevator platform 10 is adapted for mounting to a trailer body 12 having first and second sidewalls 14a and 14b, a bed 14c, and a rear wall 14d. Trailer body 12 is positioned upon and supported by a suspension system, an axle(s), and plural tire and wheel combinations which are not shown in the figures for simplicity and which are disposed upon a support surface 16 such as the ground or a floor.

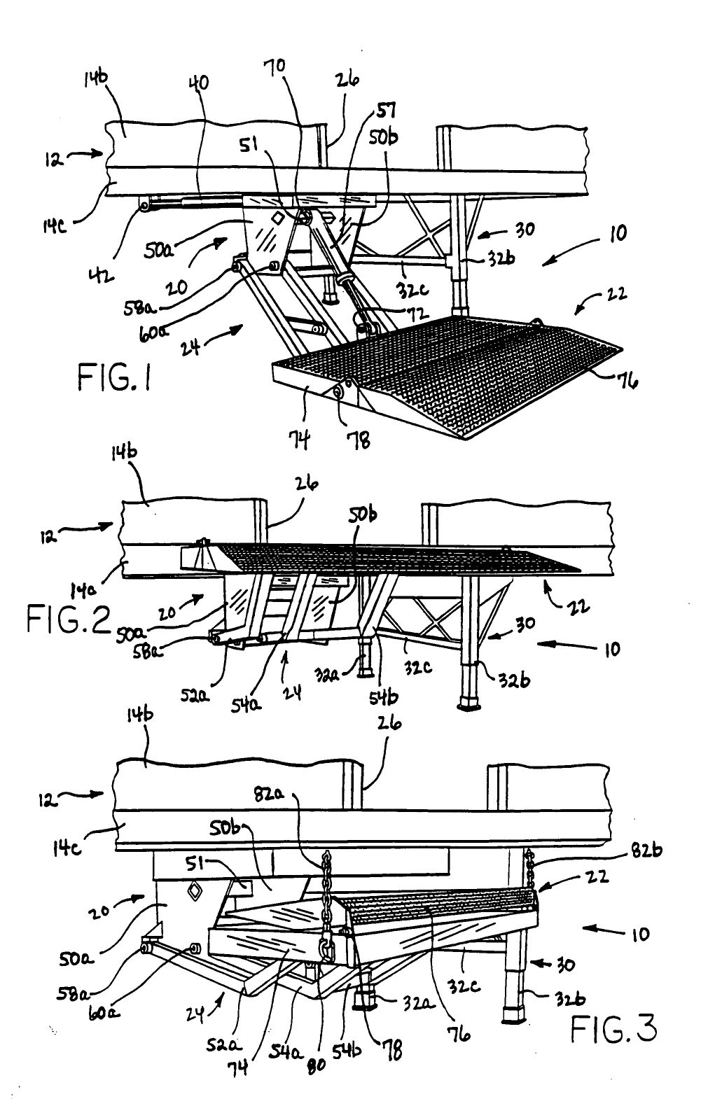

Elevator platform 10 includes a transport mechanism 10 movably attached to a lower surface of the trailer body's bed 14c. Elevator platform 10 further includes a movable lift platform 22 coupled to the transport mechanism 20 by means of operating linkage 24. Lift platform 22 in the extended, upraised position as shown in FIG. 2 is disposed adjacent to an opening 26 within sidewall 14b of the trailer body 12. Lift platform 22 is adapted for movement between the extended, fully upraised position shown in FIG. 2 and an extended, fully lowered position shown in FIG. 1. Also attached to a lower surface of the trailer body's bed 14c is an extendible support mechanism 30 which includes first and second telescoping legs 32a and 32b and a cross frame 32c. The portions of the telescoping legs 32a, 32b and cross frame 32c are fixedly attached to the lower surface of the trailer body's bed 14c. The extendible support mechanism 30 provides support for a forward portion of the trailer body 12 when the trailer body is not attached to a tractor, or truck (not shown for simplicity). The extendable support mechanism 30 is conventional in design and operation and does not form a part of the present invention.

The elevator platform's transport mechanism 20 is comprised of first and second side plates 50a and 50b which are connected together by means of plural cross members, one of which is shown as element 51 in the figures. All of the components of the transport mechanism 20, as well as of the vehicle sideloading elevator platform 10, in general, are preferably comprised of a high strength steel. Upper end portions of the transport mechanism's first and second side plates 50a, 50b are respectively attached to first and second track, or rail, assemblies 44a and 44b. Each of the track assemblies 44a, 44b is securely attached to the lower surface of the trailer body's bed 14c. First and second track assemblies 44a, 44b are arranged in parallel and are aligned with the cargo opening 26 within the trailer body's sidewall 14b. Upper end portions of each of the transport mechanism's first and second side plates 50a, 50b are provided with a respective pair of rollers 46a and 46b. Each pair of rollers 46a, 46b attached to the transport mechanism's first and second side plates 50a, 50b is inserted in and attached to a respectively one of the track assemblies 44a and 44b. Thus, the transport mechanism's first side plate 50a is slidably attached to the first track assembly 44a by means of a pair of rollers, while the transport mechanism's second side plate 50b is slidably attached to the second track assembly 44b by means of a similar pair of rollers. Disposed between the first and second track assemblies 44a, 44b and securely connected by conventional means to the transport mechanism 20 is a first hydraulic cylinder 40. With a first end of the hydraulic cylinder 40 connected to the transport mechanism 20, a second opposed end of the hydraulic cylinder is attached to a mounting bracket 42 affixed to the lower surface of the trailer body's bed 14c. As viewed in FIGS. 4-9, extension of the first hydraulic cylinder 40 causes rightward displacement of the transport mechanism 20 along the lower surface of the trailer body's bed 14c. Conversely, retraction of the first hydraulic cylinder 40 results in leftward displacement of the transport mechanism 20 along the lower surface of the trailer body's bed 14c. As shown in the figures, the rod end of the hydraulic cylinder 40 is connected to mounting bracket 42, while the butt end of the hydraulic cylinder is connected to the transport mechanism 20. Transport mechanism 20 is moved to the right as viewed in the various figures when it is desirable to put the vehicle sideloading elevator platform 10 to use, and is moved to the left as viewed in the various figures for retracting the transport mechanism in configuring the vehicle sideloading platform in the nonuse, stowed position.

Connected to an outer surface of the first side plate 50a by means of a pivot pin 58a is a first link 52a. Connected to an outer surface of the second side plate 50b by means of another pivot pin 58b is a second link 52b. Similarly, connected to an inner surface of the transport mechanism's first side plate 50a by means of a pivot pin 60a is a third link 54a. Connected to an inner surface of the transport mechanism's second side plate 50b by means of another pivot pin 60b is a fourth link 54b. Each of the aforementioned links is pivotally connected to either the first or second side plates 50a, 50b of the transport mechanism 20 at a first end of the link. Each of the first through fourth links includes two linear sections which form an obtuse angle. Each of the links is preferably comprised of a pair of linear tubular members of high strength steel which are light in weight and connected by conventional means such as a weldment. Each of the links may also be in the form of a unitary tubular member having an inner portion which is bent to form an obtuse angle. Intermediate, adjacent portions of the first link 52a and the third link 54a are pivotally connected together by means of the combination of pivot pins 66 and 68 and a first coupling link 56a. Similarly, intermediate, adjacent portions of the second and fourth links 52b, 54b are pivotally connected together by means of the combination of a pair of pivot pins (not shown in the figures for simplicity) and a second coupling link 56b. The coupling links 56a and 56b allow the four angled links to remain in parallel alignment during operation and storage of the elevator platform 10 for maintaining the lift platform 22 in a horizontal orientation.

The butt end of a second hydraulic cylinder 57 is connected to the transport mechanism's first and second side plates 50a, 50b by means of cross member 51. Hydraulic cylinder 57 is freely pivotable about cross member 51. A second, opposed rod end of hydraulic cylinder 57 is connected by means of a pivot pin 72 to a cross member 73 which is connected at opposed ends to the third and fourth links 54a and 54b. With the first and third links 52a, 54a connected to the second and fourth links 52b, 54b by means of the combination of cross link 73 and coupling links 56a and 56b, the distal ends of all four links may be raised or lowered by the retraction or extension, respectively, of hydraulic cylinder 57.

Distal ends of the first and third links 52a, 54a are pivotally connected to a main platform 74 portion of a lift platform 22 by means of pivot pins 62 and 64, respectively. Similarly, distal ends of the second and fourth links 52b, 54b are pivotally coupled to main platform 74 by a pair of pivoting pins which are not shown in the figures for simplicity. In addition to main platform 74, lift platform 22 further includes a ramp 76 which is pivotally connected to the main platform by means of a pair of pivot pins 78a and 78b. A distal end of the ramp 76 is beveled to facilitate the loading and unloading of goods unto or off of the lift platform 22. Ramp 76 is shown in the folded position relative to the main platform 74 in FIGS. 4-6, as well as in FIG. 3. Ramp 76 is shown in the extended configuration relative to main platform 74 in FIGS. 7-9, as well as in FIGS. 1 and 2. Ramp 76 maybe moved between the retracted and extended positions on main platform 74 by manually engaging the distal end portion of the ramp and pivotally displacing the ramp relative to the main platform.

The following series of steps is sequentially carried out in the operation of the vehicle sideloading elevator platform 10 in proceeding from the nonuse, stored position shown in FIGS. 3 and 6 to any of the extended use configurations shown in the various other figures. In proceeding from the nonuse, stored configuration, the second hydraulic cylinder 57 is first retracted a short distance so as to raise lift platform 22 slightly to permit restraining chains 82a and 82b to be disconnected from the lift platform to allow the lift platform to be lowered. The first hydraulic cylinder 40 then extends causing the transport mechanism 20 to be displaced rightwardly as shown in FIGS. 4-6. With the first hydraulic cylinder 40 fully extended and the transport mechanism 20 disposed generally below the cargo opening 26 within sidewall 14b, the second hydraulic cylinder 57 then extends so as to pivotally displace the first through fourth links relative to the transport mechanism 20. Extension of the second hydraulic cylinder 57 causes the first through fourth links 52a, 52b and 54a, 54b to extend downwardly from the trailer body 12 to a position such that lift platform 22 is laterally displaced from the trailer body as shown in FIG. 5. In this position, the lift platform 22 is at an intermediate height above support surface 16. The intermediate height of the lift platform 22 as shown in FIGS. 5 and 8 is between the full-up platform position shown in FIGS. 4 and 7 and the full-down position of the platform shown in FIG. 9. From the intermediate position of the lift platform 22 shown in FIGS. 5 and 8, the lift platform 22 may be raised to the fully upraised position shown in FIGS. 4 and 7 by retracting the second cylinder 57. In the fully upraised position, the lift platform 22 is disposed immediately adjacent the sidewall opening 26 within the first sidewall 14a of the trailer body 12 such as shown in FIG. 2. Retraction of the second hydraulic cylinder 57 from its extended configuration shown in FIG. 8 to its less extended configuration shown in FIG. 7 draws the distal ends of the first through fourth links 52a, 52b and 54a, 54b upward and inward toward the truck body bed 14c. Conversely, extension of the second hydraulic cylinder 57 from its configuration shown in FIG. 8 to its extended configuration shown in FIG. 9 causes the distal ends of the first through fourth links 52a, 52b and 54a, 54b to move downwardly and to the left as viewed in FIG. 9. This maintains lift platform 22 in a horizontal orientation and in closely spaced relation to, or in contact with, the support surface 16. The position of the lift platform 22 shown in FIG. 9 facilitates the loading and offloading of goods onto and off of the lift platform from the support surface 16. Similarly, the orientation and position of the lift platform 22 as shown in FIG. 7 facilitates the offloading from the trailer body 12 of goods onto the lift platform, or the offloading from the lift platform of goods onto the trailer body.

In FIGS. 7 and 8, the ramp 76 of the lift platform 22 has been rotationally displaced in a clockwise direction from the folded position of the ramp shown in FIGS. 4 and 5 so that the ramp is fully extended from the lift platform's main platform 74. Prior to moving the lift platform to the retracted, stowed configuration, ramp 76 would first be rotationally displaced so as to be positioned above and in contact with the lift platform's main platform 74 to allow for storage of the lift platform beneath the trailer body 12. From the configuration of the elevator platform 10 shown in FIGS. 8 and 9, the elevator platform is placed in the folded, stowed configuration by retracting the second hydraulic cylinder 57 to an extent as shown in FIG. 6. The extent of retraction of the second hydraulic cylinder 57 required to position the lift platform 22 at a height below that of the bed 14c of the trailer body 12 is between the extensions of the second hydraulic cylinder shown in FIGS. 7 and 8. If the second hydraulic cylinder 57 is retracted beyond the point of positioning the lift platform 22 immediately below the trailer body's bed 14c, the lift platform 22 will assume the fully upraised position shown in FIGS. 4 and 7. Similarly, the lift platform 22 may be moved from the fully upraised position shown in FIGS. 4 and 7 for storage by extending the second hydraulic cylinder 57 to an extent less than that shown in FIG. 8 such that the lift platform is positioned slightly below the level of the trailer body's bed 14c. With the lift platform 22 slightly below the trailer body's bed 14c, the transport mechanism 20, lift platform 22, and operating linkage 24 are moved to the nonuse, stowed position beneath the trailer body 12 shown in FIGS. 3 and 6 by retraction of the first hydraulic cylinder 40.

A control system for the vehicle sideloading elevator platform of the present invention could assume various conventional forms. For example, one operator control could be provided for the first hydraulic cylinder, while another operator control could be provided for the second hydraulic cylinder. Or a single control could be provided for both cylinders, with a mode switch included to select between the first and second hydraulic cylinders.

While particular embodiments of the present invention have been shown and described, it will be obvious to those skilled in the relevant arts that changes and modifications may be made without departing from the invention in its broader aspects. Therefore, the aim in the appended claims is to cover all such changes and modifications as fall within the true spirit and scope of the invention. The matter set forth in the foregoing description and accompanying drawings is offered by way of illustration only and not as a limitation. The actual scope of the invention is intended to be defined in the following claims when viewed in their proper perspective based on the prior art.

1. For use on a cargo trailer having plural sidewalls and a bottom bed, wherein one of said sidewalls has an access opening, an arrangement for loading cargo on or off-loading cargo from said trailer comprising:
a transport mechanism moveably attached to a lower portion of the trailer's bed;
a first hydraulic cylinder attached to a lower portion of the trailer's bed and coupled to said transport mechanism for moving said transport mechanism between a retracted position and an extended position wherein said transport mechanism is located adjacent said access opening;
first and second pairs of angled arms each having respective first and second opposed ends, wherein the first ends of said angled arms are pivotally coupled to said transport mechanism;
a platform adapted to receive and support cargo, wherein said platform is pivotally coupled to a second end of each of said angled arms; and
a second hydraulic cylinder coupled to an intermediate portion of each of said angled arms for moving said platform between a folded configuration when said transport mechanism is in the retracted position for transport of the trailer and an unfolded configuration when said transport mechanism is in the extended position for using said platform to receive and support cargo, wherein said platform is raised and lowered by said second hydraulic cylinder when said transport mechanism is in the extended position.

2. The arrangement of claim 1 wherein each of said arms includes first and second end sections connected end-to-end and forming an obtuse angle.

3. The arrangement of claim 2 wherein said first and second end sections are formed of tubular steel and are connected by a weldment.

4. The arrangement of claim 2 wherein each of each arms is formed of a unitary piece of tubular steel.

5. The arrangement of claim 1 further comprising tracks attached to a lower portion to the trailer bed and engaging said transport mechanism.

6. The arrangement of claim 5 further comprising plural rollers attached to an upper portion of said transport mechanism and engaging said tracks to facilitate displacement of said transport mechanism between the retracted and extended positions.

7. The arrangement of claim 1 further comprising at least one coupling link pivotally connecting each of said first pair of angled arms to one of said second pair of angled arms to allow said first and said second pairs of arms to remain generally parallel.

8. The arrangement of claim 1 wherein said second hydraulic cylinder is pivotally connected to a central portion of said transport mechanism and to an intermediate portion of each of said first and second pairs of angled arms.

9. The arrangement of claim 1 further comprising at least one chain suspended from the cargo trailer and removably connected to said platform for maintaining the platform in the folded configuration.

10. The arrangement of claim 1 further comprising a ramp pivotally coupled to a distal end of said platform and movable between a folded position on said platform when not in use and an extended position aligned with said platform to facilitate unloading goods from said platform or loading goods onto said platform.

11. A sideloading elevator apparatus disposed adjacent an opening in a side wall of a vehicle for loading cargo onto or offloading cargo from the vehicle, said apparatus comprising:
a rail assembly disposed on a lower portion of the vehicle;
a carriage attached to and displaceable along said rail assembly;
a first hydraulic cylinder disposed below and mounted to the vehicle and connected to said carriage for displacing said carriage on said rail assembly between a nonuse, storage position and an extended, use position;
a generally flat platform adapted for receiving and supporting cargo and including a foldable ramp;
plural angled arms each having respective first and second opposed ends, wherein the first ends of said arms are pivotally coupled to said carriage and the second ends of said arms are pivotally coupled to said platform, and wherein each of said arms forms an obtuse angle;
coupling links pivotally connecting adjacent pairs of angled arms for maintaining said arms generally parallel and said platform generally horizontal; and
a second hydraulic cylinder coupled between said carriage and an intermediate portion of each of said angled arms for pivotally displacing said arms about said carriage and moving said platform between an elevated position adjacent the opening in the vehicle's side wall and a lowered position on or adjacent the ground when said carriage is in the extended, use position.
